(19) United States
(12) Patent Application Publication
(10) Pub. No.: US 2017/0099119 A1
(43) Pub. Date: Apr. 6, 2017

(54) SIGNALLING OF CHECKSUM FOR 802.11 MAC HEADERS

(71) Applicant: Samsung Electronics Co., Ltd., Gyeonggi-do (KR)

(72) Inventors: Mark G. RISON, Cambridge (GB); Fei TONG, Bassingbourn (GB)

(21) Appl. No.: 14/989,574

(22) Filed: Jan. 6, 2016

Related U.S. Application Data
(60) Provisional application No. 62/236,604, filed on Oct. 2, 2015.

(51) Int. Cl. H04L 1/00; H04L 29/12; H04L 29/06

(52) U.S. Cl. CPC H04L 1/0061; H04L 69/22; H04L 61/6022

(57) ABSTRACT

Methods, systems, and apparatuses (including, but not limited to portable devices and modem chips) for generating an error-check on the header of a medium access control (MAC) protocol data unit (PDU) (MPDU). This error-check is then inserted, at least in part, in the MAC header and/or the PHY layer PDU (PPDU) which will contain the MPDU. A separate indicator can be used to indicate whether any particular MAC frame has an error-check for its MAC header. Upon reception, the header of the MAC frame is processed and checked against the error-check inserted on the transmission side in order to determine whether the MAC header has an error.

### PRIORITY

This application claims priority under 35 U.S.C. §119(e) to U.S. Provisional Patent Application Ser. No. 62/236,604 filed on Oct. 2, 2015, the entire disclosure of which is incorporated herein by reference.

### BACKGROUND

1. Field of the Disclosure

The present disclosure relates generally to providing an error check for the header of a packet, and more particularly to providing an error check for the header of a Medium Access Control (MAC) frame.

2. Description of the Related Art

In general, most packet-based communication systems have a Medium Access Control (MAC) layer or sub-layer, which receives data from a preceding layer, appropriately frames it, and passes that data to the next layer. As an example, the general frame format 100 for a MAC sub-layer in the Institute of Electrical and Electronic Engineers (IEEE) standard 802.11 is shown in FIG. 1. See, e.g., IEEE Std 802.11-2012, IEEE Standard for Information technology—Telecommunications and information exchange between systems—Local and metropolitan area network—Specific requirements—Part 11: Wireless LAN Medium Access Control (MAC) and Physical Layer (PHY) specifications (hereinafter “IEEE Std 802.11-2012”), which is incorporated herein by reference in its entirety. A MAC frame is also called a MAC Protocol Data Unit (MPDU).

General frame format 100 has three basic components: a MAC header 125, a variable-length Frame Body 150, which carries the data/payload, and a frame check sequence (FCS) 175. The first three fields (Frame Control, Duration/ID, and Address 1) and the last field (FCS) in FIG. 1 constitute a minimal frame format. The fields Address 2, Address 3, Sequence Control, Address 4, Quality of Service (QoS) Control, High Throughput (HT) Control, and Frame Body are present only in certain frame types and subtypes. Each field is defined in subclause 8.2.4 of IEEE Std 802.11. FCS 175 is a 32-bit field containing a cyclic redundancy check (CRC) of the entire MAC frame, including the MAC header. The receiver uses the FCS to determine whether the MAC frame has any errors before actually processing the frame.

As is well-known to one of ordinary skill in the art, there are many different types of MAC frames, as the MAC sub-layer or layer is implemented in almost every electronic device capable of communication. Despite this, the MAC frames and their headers do share some general characteristics. FIG. 2 shows the MAC frame 200 according to the Wi-Fi Alliance® Multimedia Technical Specification, ver. 1.2.0 (May 7, 2012) (hereinafter “WMM”), which is incorporated herein by reference in its entirety. For example, both the WMM MAC header in FIG. 2 and the IEEE Std 802.11-2012 MAC header in FIG. 1 have a QoS Control field.

In both MAC frames in FIGS. 1 and 2, the FCS at the end provides the CRC of the entire MAC frame, which the receiver uses to determine whether the MAC frame has any errors.

However, this means the entire frame must be received before the error determination can be made because FCS 175 is at the end of the frame. Thus, for example, if the data payload in the Frame Body 150 was 7 KB, all of that data must be stored before determining that there was an error in the Duration/ID field, even though this field is at the second byte in the frame. This wastes resources, including time, storage, and power, as well as precluding other optimizations.

Thus, there is a need for methods, systems, and apparatuses (including, but not limited to portable devices and modem chips) which provide greater efficiency in managing MAC frames.

### SUMMARY

The present disclosure addresses at least the problems and disadvantages described above and provides at least the advantages described below.

According to an aspect of the present disclosure, a method for generating a medium access control (MAC) protocol data unit (PDU) (MPDU) is provided, including generating an error-check from a header of the MPDU; and inserting an indicator and the error-check into one or more fields of the MAC header, where the indicator indicates that the MAC header of the MPDU has an error-check.

According to another aspect of the present disclosure, a method is provided, including generating a medium access control (MAC) protocol data unit (PDU) (MPDU); generating an error-check from the header of the MPDU; supplying, to the PHY layer, at least one bit from at least one of the error-check and an indicator that the MAC header of the MPDU has the error-check; and generating, by the PHY layer, a PHY layer PDU (PPDU) from the MPDU and the supplied at least one bit from at least one of the error-check and the indicator that the MAC header of the MPDU has the error-check, wherein the supplied at least one bit from at least one of the error-check and the indicator that the MAC header of the MPDU has the error-check is not in the MPDU.

According to yet another aspect of the present disclosure, a modem chip is provided, including at least one processor and at least one non-transitory computer-readable medium storing instructions, which, when executed by one or more of the at least one processor, control the modem chip to perform a method including generating a medium access control (MAC) protocol data unit (PDU) (MPDU); generating an error-check from the header of the MPDU; generating an indicator that the MAC header of the MPDU has an error-check; and inserting the indicator and error-check into a PDU including the MPDU.

### BRIEF DESCRIPTION OF THE DRAWINGS

The above and other aspects, features and advantages of certain embodiments of the present disclosure will become more apparent from the following detailed description taken in conjunction with the accompanying drawings, in which:

FIG. 1 is a diagram of the fields in a MAC frame in accordance with IEEE Std 802.11-2012;

FIG. 2 is a diagram of the fields in a MAC frames in accordance with the WMM Wi-Fi standard;

FIG. 3A is a flow chart of a general transmission method according to an embodiment of the present disclosure; and

FIG. 3B is a flow chart of a general reception method according to and embodiment of the present disclosure.

### DETAILED DESCRIPTION OF EMBODIMENTS OF THE PRESENT DISCLOSURE

Various embodiments of the present disclosure will be described in detail below with reference to the accompanying drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

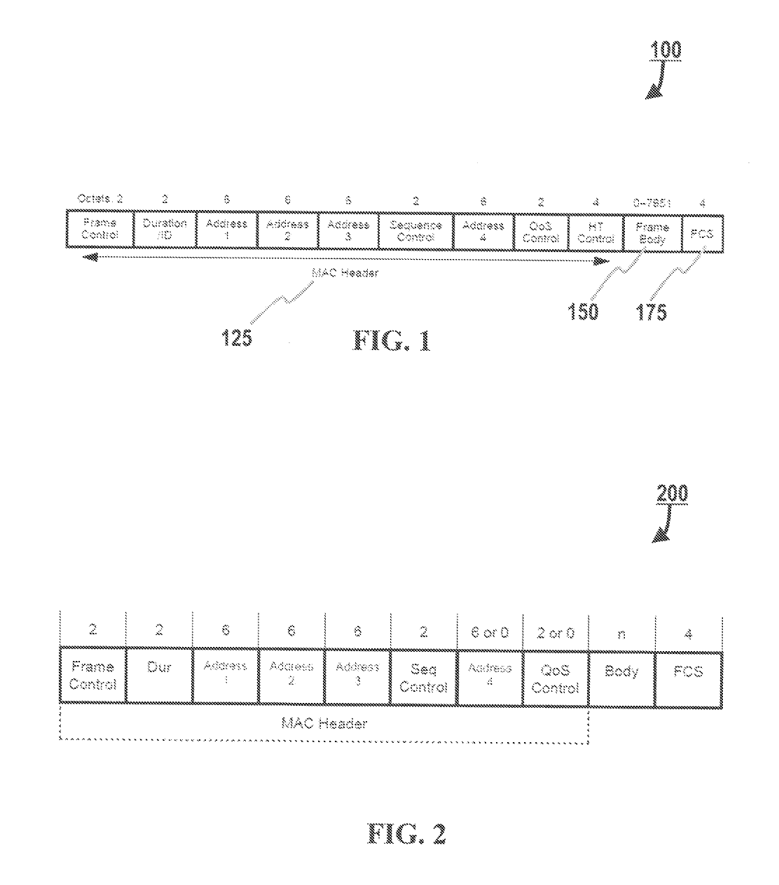

Moreover, the present disclosure is of general applicability, and is not limited to any particular type or “flavor” of MAC frame. Accordingly, even though specific embodiments described below may use the framework provided by, e.g., the IEEE Std 802.11-2012 MAC frame as shown in FIG. 1 and the WMM MAC frame shown in FIG. 2, the present disclosure is not limited thereto.

According to embodiments of the present disclosure, specific techniques are provided for including an error-check of the MAC header of an MPDU, either in the MPDU itself or in the Physical layer (PHY) PDU (PPDU) which encapsulates the MPDU. The specific techniques remain backwards-compatible with existing/legacy MPDU/PPDU implementations, as well as being modifiable so they will be able to apply to developing/future MPDU/PPDU implementations. In this application, the terms “error-check” and “error check” are used to indicate coverage of the field of error detection/correction or error control which, although it includes common methods such as cyclic redundancy check (CRC), a parity check, an XOR check, and a checksum or hash algorithm, also covers a wide variety of error detection/correction or error control systems/methods/procedures.

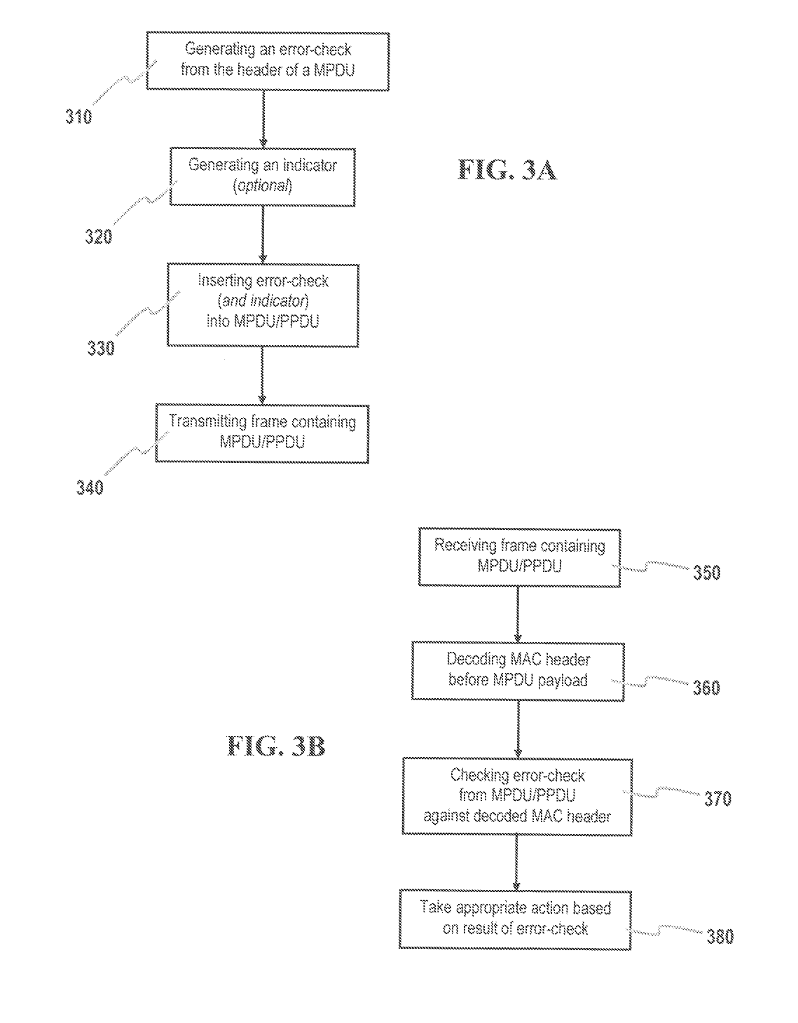

FIGS. 3A and 3B are flow charts of a general method on the transmission-side and a general method on the reception-side, respectively, according to embodiments of the present disclosure. As would be understood by one of ordinary skill in the art, FIGS. 3A and 3B are simplified/conceptual representations of the actions performed, and the details of real-world implementations and/or intermediate/required steps/processes as known and understood by one of ordinary skill in the art and not pertinent and/or helpful to the present description are omitted.

In step 310 of FIG. 3A, an error-check is generated from the MAC header of a MPDU. In step 320 (which is optional), an indicator that an error-check of the MAC header is present in the frame is generated. In step 330, the error-check and optionally the indicator are inserted into the MPDU and/or PPDU of the frame and, in step 340, the frame is transmitted. In step 350 of FIG. 3B, the frame is received and, in step 360, the MAC header is decoded before the MPDU payload. In step 370, the error-check received with the frame is used to check the decoded MAC header. At step 380, appropriate action is taken based on the results of the error-check. As discussed below, many different actions may be taken in step 380 in accordance with the present disclosure.

Some of those actions include, but are not limited to:
If the decoded MAC header is found to be valid but also shows that the MAC frame is addressed to a different station, there is no need to receive the rest of the MAC frame (note that the end of the frame exchange will be known from the Duration field of the decoded MAC header);
If the decoded MAC header is found to be valid and shows that the MAC frame is addressed to the station, then if the frame body/payload is corrupted, the extended interframe space (EIFS) need not be invoked since the Duration is known from the MAC header, and/or a negative acknowledgment operation could safely be invoked since, again, the addresses are known from the MAC header already; and
The receiving entity can fall asleep while receiving an identified faulty MAC frame, thereby saving resources.

Both decoding the MAC header initially and separately/before the payload and having an error-check for only the MAC header provide many advantages. Some additional features and advantages provided by being able to decode and detect errors in the MAC header before decoding the entire MAC frame are discussed in U.S. Pat. App. Pub. No. 2009/0103485, which was filed by the present assignee, and is also incorporated by reference in its entirety. Indeed, the actions that could be taken once an error is detected according to embodiments of the present disclosure are practically unlimited.

However, a key question is how to introduce, e.g., where to place, the MAC header error-check within the overall frame. Existing (legacy) devices need to be able to extract the same information as always from the same locations within the frame (such as, e.g., Duration/ID and Addresses), thus wherever the MAC header error-check bits are placed should have the least impact as possible on the fields of the MAC header in use. Furthermore, it would be desirable to also have an indicator within the frame indicating whether the frame contains such a MAC header CRC or is instead a legacy/normal frame—a feature which is sometimes referred to as being “self-describing”.

If the frame is not in some way self-describing, the receiver would need another means to determine whether a received frame even has a MAC header error-check. It could, for example, be determined based on the transmitter address (presuming the transmitter had been previously identified as sending frames with MAC header error-checks). This, however, is of limited use, because the transmitter address can only be determined by decoding the MAC header itself, whose validity is not known until the error-check has already been performed. Accordingly, having a separate indicator that a MAC header CRC is present is desirable, even though not necessary.

In the specific embodiments discussed below, a CRC is used as the error check for the MAC header, but this is only one example of the possible error-check systems/methods which could be used in accordance with the present disclosure. For example, a checksum, a parity check, an XOR check, etc., could also be used in accordance with embodiments of the present disclosure, as well as many others, as would be understood by one of ordinary skill in the art. Similarly, while it is desirable for the signalling to be self-describing, i.e., for an indicator to be sent as well as the error-check itself, this is not required in accordance with embodiments of the present disclosure.

Four options for placing the MAC header data (i.e., an indicator and the MAC header CRC itself) in accordance with embodiments of the present disclosure are discussed below:

1. in the QoS Control field of the MAC header itself;

2. in the HTC field of the MAC header itself;

3. in the PHY layer PPDU; and

4. in the MPDU and PPDU.

As would be understood by one of ordinary skill in the art, the constraints set by relevant standards developing organizations will necessarily affect how best to implement any embodiment of the present disclosure, including the examples discussed below.

### Option 1: QoS Control Field in MPDU Mac Header

In MAC frames which have a QoS Control field in the MAC header, some or all of the bits of the QoS Control field could be used to indicate both the presence of a MAC header CRC and the MAC header CRC itself. Of course, this would only work for frames which carry a QoS Control field, i.e., (QoS) Data frames, and not Control or Management frames, which do not. For both options 1 and 2, the MAC header CRC can be computed by setting the fields it occupies in the MAC header to zero, or by omitting these fields from the CRC input bitstring, or by other means, as would be understood by one of ordinary skill in the art. As would be understood by one of ordinary skill in the art, the constraints set by standards developing organizations may require modifications to any of the examples presented below.

a) In an IEEE Std 802.11 MAC Header

As shown in FIG. 1, the IEEE Std 802.11 MAC header has a two byte (16 bit) QoS Control field, whose bits are broken up into sections, as shown in Table 1A below. In short, there are five sections, comprising bits 0-3 (b0-b3); bit 4 (b4); bits 5-6 (b5-b6), bit 7 (b7), and bits 8-15 (b8-b15). The type of content of the various sections vary according to the type of frame or sub-frame of which its MAC header is a part. Table 1A is a summary of the possible types of content, as indicated by the “or” between types. Thus, while b0-b3 and b5-b6 are always the TID (traffic identifier) and Ack policy, respectively, b8-b15 may be any of six possibilities. Table 1A is based on Table 8-4 in IEEE Std 802.11, which shows what types of sub-/frames have which type of content. More details concerning the QoS Control field can be found in clause 8.2.4.5 of the IEEE Std 802.11 (which, as stated above, is incorporated herein by reference in its entirety).

TABLE 1A
802.11 MAC QoS Control field

| b0-b3 | b4 | b5-b6 | b7 | b8-b15 |
|---|---|---|---|---|
| TID | EOSP or | Ack | A-MSDU | TXOP Limit or |
| | 0/1 or | Policy | Present | AP PS Buffer State or |
| | reserved | | or reserved | TXOP Duration Requested |
| | | | | or Queue Size or |
| | | | | mesh control or |
| | | | | reserved |

While the IEEE Std 802.11 has many types of data indicated for b8-b15 (e.g., “TXOP Limit”, “AP PS Buffer Size”, “TXOP Duration Requested”, “Queue Size”, and mesh control information), in actual practice, the QoS Control field usually does not carry such data. Instead, most implementations do not use the QoS Control field at all, following the Wi-Fi Alliance WMM specification for those bits (to be discussed further below).

Because of this, b8-b15 can presently be used to carry MAC header CRC data in an embodiment of the present disclosure. As discussed above, it is desirable to provide two pieces of information: (1) an indication that there is a MAC header CRC present; and (2) the MAC header CRC itself. Accordingly, a bit, such as the first bit, in b8-b15 could be a flag indicating the presence or lack of MAC header CRC (“MAC CRC Flag”) and the remaining bits may be the calculated MAC header CRC itself, which could be 7 bits long at most. This is shown in Table 1B below, where the new section is shaded.

TABLE 1B
802.11 MAC QoS Control field
according to the present disclosure

| b0-b3 | b4 | b5-b6 | b7 | b8-b15 |
|---|---|---|---|---|
| TID | EOSP or | Ack | A-MSDU | MAC CRC Flag - 1 bit + |
| | 0/1 or | Policy | Present | MAC header CRC - 7 bits |
| | reserved | | or reserved | |

However, for a variety of reasons, including that the QoS Control field may be used for other functions, it would be desirable to have prior signalling to establish that the QoS Control field is being used for MAC header CRC data rather than the legacy information, or a prior agreement that everyone in the BSS will use the new form. In such scenarios, the flag would not be necessary, and an 8-bit MAC header CRC could be used instead of a 7-bit CRC.

b) In a WMM MAC Header

As shown in FIG. 2, the WMM MAC header has a QoS Control field, which is 2 bytes. When comprising two bytes (bits 0-15), the sections of the QoS Control field are as shown in Table 2A below, which was based on FIG. 4 in Sect. 2.1.6 of WMM (which, as stated above, is incorporated herein by reference in its entirety). In short, there are six sections, comprising bits 0-2 (b0-b2); bit 3 (b3); bit 4 (b4); bits 5-6 (b5-b6); bit 7 (b7); and bits 8-15 (b8-b15). As previously mentioned, WMM does not presently use b8-b15 for anything (as indicated by“0” in Table 2A).

TABLE 2A
WMM MAC QoS Control field

| b0-b2 | b3 | b4 | b5-b6 | b7 | b8-b15 |
|---|---|---|---|---|---|
| UP | 0 | EOSP | Ack | A-MSDU | 0 |
| | | | Policy | Present | |

Thus, b8-b15 can clearly be used for MAC header CRC data. However, the WMM MAC QoS field also has another empty field, b3 (as indicated by the “0” in Table 2A). Thus, the MAC header CRC flag could be placed in b3, while an 8-bit MAC header CRC can be placed in b8-b15, as shown in Table 2B:

TABLE 2B
WMM MAC QoS Control field
according to the present disclosure

| b0-b2 | b3 | b4 | b5-b6 | b7 | b8-b15 |
|---|---|---|---|---|---|
| UP | MAC CRC | EOSP | Ack | A-MSDU | MAG header CRC - |
| | Flag | | Policy | Present | 8 bits |

### Option 2: HT Control Field in MPDU Mac Header

In MAC frames which have a HT Control (HTC) field in the MAC header, as shown in FIG. 1, some or all of the bits of the HTC field could be used to indicate both the presence of a MAC header CRC and the MAC header CRC itself. Of course, this would only work for frames which carry a HTC field. See, e.g., subclause 8.2.4.6 of IEEE Std 802.11-2012 for more information concerning the HT Control field.

The HT Control field has two variants, as first described in subclause 8.2.4.6 of IEEE Std 802.11 ac-2013—Part 11: Wireless LAN Medium Access Control (MAC) and Physical Layer (PHY) specification—Amendment 4: Enhancements in Very High Throughput for Operation in Bands below 6 GHz, approved 11 Dec. 2013 (hereinafter “IEEE Std 802.11ac-2013”), which is incorporated herein by reference in its entirety. The two variants are the HT variant and the very HT (VHT) variant.

Moreover, this would only work for HT or VHT/TVHT PPDUs, and not for, e.g., direct sequence spread spectrum (DSSS), OFDM, or extended rate PHY (ERP) PPDUs, since only the HT-type PPDUs can contain this field (as signalled by the Order bit in the Frame Control field of the MAC header), if the special case of Control Wrapper frames is ignored. Between 1 and 31 bits (inclusive) could then be used to hold a MAC header CRC. If fewer than 31 bits were used, then some of the remaining bits could be used to maintain some of the existing HT Control functionality, e.g. solicited MCS feedback.

Of course, embodiments of the present disclosure are not limited by the examples below, but, for example, may be modified depending on the implementation and/or depending on the constraints set by the relevant standards developing organizations, as would be understood by one of ordinary skill in the art.

a) In an HT Variant HT Control Field

The sections of the HT variant HT Control field are shown in Table 3A below, which is based roughly on FIGS. 8-5 and 8-5a in subclause 8.2.4.6 of IEEE Std 802.11ac-2013. In Table 3A, b0 is the VHT subfield, which is set to “0” if it is a HT variant and “1” if it is a VHT variant; b1-b15 is the Link Adaptation (LA) control field; b16-b19 and b22-b24 contain subfields concerning beamforming (BF) control; b29-b31 contain subfields for DEI and reverse direction (RD) control; and b20-b21 and b25-b28 are reserved.

TABLE 3A
HT Variant HT Control field

| b0 | b1-b15 | b16-b19 | b20-b21 | b22-b24 | b25-b28 | b29-b31 |
|---|---|---|---|---|---|---|
| 0 | LA control | BF | Reserved | BF | Reserved | DEI + |
| | | control | | control | | RD ctrl |

Based on Table 3A above, b20, b21, and b25-28 can be used for MAC header CRC data. Thus, the MAC header CRC flag could be placed in b20, while an 8-bit MAC header CRC can be placed in b21-b28, as shown in Table 3B:

TABLE 3B
HT variant HT Control field
according to the present disclosure

| b0 | b1-b15 | b16-b19 | b20 | b21-b28 | b29-b31 |
|---|---|---|---|---|---|
| VHT | LA | 0 | MAC CRC | MAC header | DEI + |
| (=0) | control | | Flag | CRC - 8 bits | RD control |

b) In a VHT Variant HT Control Field

The sections of the VHT variant HT Control field are shown in Table 4A below, which is based roughly on FIGS. 8-5 and 8-8a in subclause 8.2.4.6 et seq. of IEEE Std 802.11 ac-2013. In Table 4A, b0 is the VHT subfield, which is set to “1” because it is a VHT variant; b1 is reserved; b2-b23 contain subfields concerning solicited LA control; b24-b29 contain subfields concerning unsolicited LA control; and b30-b31 contain subfields for RD control.

TABLE 4A
VHT variant HT Control field

| b0 | b1 | b2-b23 | b24-b29 | b30-b31 |
|---|---|---|---|---|
| VHT | Reserved | LA | Unsolicited LA | RD |
| (=1) | | control | control | control |

Based on Table 4A above, only b1 can be used for MAC header CRC data. Accordingly, choices need to be made about what sections of the field will be repurposed for sending MAC header CRC data. Such a choice would depend on the particular implementation and situation, and factors such as the relative perceived value of the different forms of LA would need to be considered. Of course, as with all of the embodiments of the present disclosure, the constraints set by the relevant standards developing organizations may also affect how best to implement any embodiment of the present disclosure.

Three examples are provided below. In Table 4B, the Unsolicited LA control section b24-b29 is overwritten; in Table 4C, parts of the LA Control section b2-b23 and parts of Unsolicited LA control section b24-b29 are overwritten; and, in Table 4D, the Unsolicited LA Control section b24-b29 and the RD control section b30-b31 are overwritten.

Thus, Table 4B below preserves the use of the solicited LA control and RD control sections, but removes the unsolicited LA control section.

TABLE 4B
VHT variant HT Control field
according to the present disclosure

| b0 | b1 | b2-b23 | b24-b29 | b30-b31 |
|---|---|---|---|---|
| 1 | MAC CRC | LA | MAC header CRC - | RD |
| | Flag | control | 6 bits | control |

Thus, Table 4C below preserves the use of only the RD control section, and removes the solicited and unsolicited LA control sections. Table 4C only shows one example of where the MAC header CRC could be placed within b2-b28.

TABLE 4C
VHT variant HT Control field
according to the present disclosure

| b0 | b1 | b2-b20 | b21-b28 | b29 | b30-b31 |
|---|---|---|---|---|---|
| 1 | MAC CRC | 0 | MAC header CRC - | 0 | RD |
| | Flag | | 8 bits | | control |

Thus, Table 4D below preserves the use of only the solicited LA control section, and removes the RD control and unsolicited LA control sections.

TABLE 4D
VHT variant HT Control field
according to the present disclosure

| b0 | b1 | b2-b23 | b24-b31 |
|---|---|---|---|
| 1 | MAC CRC | LA | MAC header CRC - |
| | Flag | control | 8 bits |

### Option 3: PHY Layer/PPDUs

Rather than putting the MAC header data into the MAC frame, the MAC header data could be placed in the physical layer (PHY) frame which contains the MAC frame with the corresponding MAC header. This would only work for non-aggregate MPDUs (A-MPDUs) or A-MPDUs containing only one MPDU, although it could be used to support, e.g., the first MPDU in an A-MPDU.

In the embodiments described below, the PPDU carries the MAC header CRC data at various locations, depending on, among other things, the type of sub-/frame. As an aside, it should be noted that, although the acronym “PPDU” originally stood for Physical Layer Convergence Procedure (PLCP) Protocol Data Unit (PPDU), the IEEE has indicated it may equivalently refer to a PHY (layer) PDU, which has become the more common usage. See, e.g., clause 3.3 of IEEE Std 802.11 ac-2013. As used herein, the term should be interpreted in its broadest sense. In general, refer to IEEE Std 802.11-2012 (which, as stated above, is incorporated herein by reference in its entirety) for more information concerning PLCP, the PHY layer, and the PPDU, as this disclosure will focus only on those things most pertinent to the explanation of the embodiments.

Depending on the embodiment of the present disclosure, it may be desirable to have a common MAC header CRC size for Option 3. For example, the CRC could be 4 or 5 bits if DSSS and HR/DSSS are to be supported, and 7 bits otherwise. As another example, depending on the implementation, it may be desirable to make the CRC as big as will fit the available space. As mentioned above, another factor to consider in these determinations will be the constraints set by the relevant standards developing organizations.

a) HT/OFDM/ERP PPDUs

This section discusses (1) the high throughput (HT) PHY implementation PPDUs as discussed in clause 20 of IEEE Std 802.11 (which, as stated above, is incorporated herein by reference in its entirety) and presently developing; (2) the Orthogonal Frequency Division (OFDM) PHY implementation PPDUs as discussed in clause 18 of IEEE Std 802.11 and presently developing; and (3) the Extended Rate PHY (ERP) layer implementation PPDUs as discussed in clause 19 of IEEE Std 802.11 and presently developing.

There are variations and continuing developments among these implementations concerning the size, type, and number of fields in the PHY frame; however, the SERVICE field is 16 bits long, with the first 7 bits (b0-b6) being used for scrambler initialization while the remaining 9 bits (b7-b15) are presently reserved. See, e.g., subclause 18.3.5.2 of IEEE Std 802.11-2012. Thus, at least b7-b15 can be used for MAC header data. For example, in Table 5A, both the MAC CRC flag and the MAC header CRC itself are placed in the SERVICE field:

TABLE 5A
HT/OFDM/ERP PPDU SERVICE Field
(both flag and CRC in the field)
according to the present disclosure

| b0-b6 | b7 | b8-b15 |
|---|---|---|
| Scrambler | MAC CRC | MAC header CRC - |
| initialisation | flag | 8 bits |

Alternatively, the flag, CRC, and/or parts of them may placed in other areas as well as the SERVICE field or perhaps pre-transmitted/signalled (e.g., pre-signalling to indicate a frame with a MAC header CRC is/will be arriving). For example, Table 5B only has the MAC header CRC in the SERVICE field, but not the MAC CRC flag. In Table 5B, two possibilities are considered for the MAC CRC flag. First, if it is an HT PPDU, b26 of the HT-SIG field could be used for the MAC CRC flag. Second, if it is an OFDM or ERP PPDU, b4 of the SIGNAL field could be used for the MAC CRC flag. Of course, these are only examples. Where the MAC CRC flag could be located will depend upon the standardization, as would be understood to one of ordinary skill in the art.

TABLE 5B
HT/OFDM/ERP PPDU SERVICE Field
(only CRC in field; flag elsewhere)
according to the present disclosure

| b0-b6 | b7 | b8-b15 |
|---|---|---|
| Scrambler | 0 | MAC header CRC - 8 bits |
| initialisation | | (where: |
| | | in an HT PHY header: |
| | | MAC CRC flag = b26 of HT-SIG field; or |
| | | in an OFDM PHY/ERP header: |
| | | MAC CRC flag = b4 of SIGNAL field) |

As would also be understood by one of ordinary skill in the art, specific implementations may require further variations in form. For example, in PPDUs carrying a so-called “signalling TA”, b4-b6 of the scrambler initialization field are used to carry dynamic bandwidth information, and thus would not be available for use. However, in that case, b0-b3 could still be used in addition to b7-b15, thereby providing a total of 13 bits available for use.

b) VHT PPDUs

This section discusses the very high throughput (HT) PHY implementation PPDUs as described in clause 22 of IEEE Std 802.11 ac-2013 (which, as stated above, is incorporated herein by reference in its entirety) and presently developing.

There are variations and continuing developments in the size, type, number, and format of fields among implementations; however, the SERVICE field for the VHT PPDU is 16 bits long, with the first 7 bits (b0-b6) being used for scrambler initialization, the next bit (b7) being reserved, while the remaining 8 bits (b8-b15) are used for the CRC of the VHT signal B field (VHT-SIG-B CRC). See, e.g., subclause 22.3.10.2 of IEEE Std 802.11ac-2013.

Thus, for example, reserved bit b7 could be used to indicate the absence/presence of a MAC header CRC (MAC CRC flag), and the 7 scrambler initialization bits b0-b6 could be used to carry the MAC header CRC, as shown in Table 6A below. Note that in this case the MAC header CRC could not be used if its value was all-zeros, so on average about 1% of frames would not have a MAC header CRC; or alternatively all-ones could be signalled, and the receiver would in that case accept a computed MAC header CRC of all-zeros or all-ones.

TABLE 6A
VHT PPDU SERVICE Field
(both flag and CRC in field) according
to the present disclosure

| b0-b6 | b7 | b8-b15 |
|---|---|---|
| Scrambler initialisation, and, possibly | MAC CRC | VHT-SIG-B CRC |
| MAC header CRC* | flag | |

*b0-b6 will be all-ones if MAC header CRC is all zeros

Alternatively, the flag, CRC, and/or parts of them may placed in other areas as well as the SERVICE field or perhaps pre-transmitted/signalled (e.g., pre-signalling to indicate a frame with a MAC header CRC is/will be arriving). For example, because single user (SU) PPDUs have a currently reserved bit in the VHT-SIG-B field, this bit could be used to indicate the absence/presence of a MAC header CRC (e.g., MAC CRC flag), while and 1 to 8 bits in the SERVICE field could then be used to carry the MAC header CRC, as shown in Table 6B below. Of course, this would only work for SU PPDUs, but the principle may be applied to any currently free/unused/reserved bit in any location within the PPDU.

TABLE 6B
VHT PPDU SERVICE Field
(only CRC in field; flag elsewhere)
according to the present disclosure

| b0-b6 | b7 | b8-b15 |
|---|---|---|
| Scrambler initialisation, | 0 or the last | VHT-SIG-B CRC |
| and, possibly first 7 bits of | bit of the | |
| MAC header CRC* | MAC header CRC | |

*b0-b6 will be all-ones if MAC header CRC is all zeros

c) DSSS and HR/DSSS PPDUs

This section discusses the direct sequence spread spectrum (DSSS) and the High Rate DSSS (HR/DSSS) PPDUs as described in clauses 16 and 17, respectively, of IEEE Std 802.11-2012 (which, as stated above, is incorporated herein by reference in its entirety) and presently developing. See, e.g., FIGS. 16-1 and 17-2 for PHY frame formats in IEEE Std 802.11-2012.

There are, and will be more, variations in the size, type, number, and format of fields among implementations and over time as the standards develop. All of the following is intended merely as an example of the general principle.

Thus, for example, reserved bit b0 could be used to indicate the absence/presence of a MAC header CRC (MAC CRC flag), and reserved bits b1, b4, b5, and b6 could be used to carry a 4 bit MAC header CRC, as shown in Table 8A below.

TABLE 8A
DSSS and HR/DSSS PPDU SERVICE Field
(with flag and 4-bit MAC header CRC)
according to the present disclosure

| b0 | b1 | b2 | b3 | b4 | b5 | b6 | b7 |
|---|---|---|---|---|---|---|---|
| MAC | 1^{st} bit of | Locked | Mod. | 2^{nd} bit of | 3^{rd} bit of | 4^{th} bit of | Length |
| CRC | MAC | clocks | Selection | MAC | MAC | MAC | extension |
| flag | header | | bit | header | header | header | |
| | CRC | | | CRC | CRC | CRC | |

Alternatively, a 5 bit MAC header CRC could be carried by the SERVICE field as shown by Table 8B below:

TABLE 8B
DSSS and HR/DSSS PPDU SERVICE Field
(with flag and 5 bit MAC header CRC)
according to the present disclosure

| b0 | b1 | b2 | b3 | b4 | b5 | b6 | b7 |
|---|---|---|---|---|---|---|---|
| MAC | 1^{st} bit of | Locked | 2^{nd} bit of | 3^{rd} bit of | 4^{th} bit of | 5^{th} bit of | Length |
| CRC | MAC | clocks | MAC | MAC | MAC | MAC | extension |
| flag | header | | header | header | header | header | |
| | CRC | | CRC | CRC | CRC | CRC | |

As indicated above, the size of the MAC header CRC may vary by embodiment, implementation, environmental and/or technical requirements, etc. In some embodiments, a common set MAC header CRC size may be preferable; in other embodiments, a range of variability in MAC header CRC size may be preferred; in still other embodiments, the maximum possible MAC header CRC may be the goal. In any event, embodiments of the present disclosure are not limited to having a set size, a variable range of sizes, variable sizes based on one or more conditions, etc.

d) Other Types of PPDUs

The examples above provide a working understanding of how to, according to embodiments of the present disclosure, appropriately allocate the bits required to transmit a MAC header CRC and, optionally, a MAC header CRC flag indicating whether a MAC header CRC is present in the instant frame.

### Option 4: Using Both the MPDU and the PPDU

Although the examples above only discuss placing MAC header data either within a MPDU or within a PPDU, embodiments of the present disclosure are not so limited. According to some embodiments of the present disclosure, the MAC header data may be split between the MPDU and PPDU. For example, the indicator may be placed in the PPDU, while the error-check may be placed in the MPDU, or vice-versa. As another example, the bits of the error-check may be split between the MPDU and the PPDU. The embodiments described above provide a working understanding of a method and approach to allocate the bits forming MAC header data in MPDUs and/or PPDUs. Of course, as with all of the embodiments of the present disclosure, the constraints set by the relevant standards developing organizations will affect how best to implement any embodiment of the present disclosure.

Similar techniques to those discussed above can be applied to other types of MPDUs and PPDUs, such as a directional multi-gigabit (DMG) PPDU, and to other MPDU/PPDUs under consideration or development. See, e.g., P802.11-REVmc/D4.0, January 2015—IEEE Draft Standard for Information technology—Telecommunications and information exchange between systems Local and metropolitan area networks—Specific requirements Part 11: Wireless LAN Medium Access Control (MAC) and Physical Layer (PHY) Specifications; P802.11ah/D5.0, March 2015—IEEE Draft Standard for Information Technology-Telecommunications and Information Exchange Between Systems-Local and Metropolitan Area Networks-Specific Requirements-Part 11: Wireless LAN Medium Access Control (MAC) and Physical Layer (PHY) Specifications: Amendment 2: Sub 1 GHz License Exempt Operation; and 802.11ad-2012—IEEE Standard for Information technology—Telecommunications and information exchange between systems—Local and metropolitan area networks—Specific requirements-Part 11: Wireless LAN Medium Access Control (MAC) and Physical Layer (PHY) Specifications Amendment 3: Enhancements for Very High Throughput in the 60 GHz Band, all of which are incorporated by reference in their entireties.

In some cases, it is a simple modification of one of the example applications described above. For example, because it behaves much like a VHT or OFDM PPDU, the modifications to a Television VHT (TVHT) PPDU for use in the television white spaces/frequency bands (TVWS) would be readily apparent to one of ordinary skill in the art. See IEEE Std 802.11af-2013—Part 11: Wireless LAN Medium Access Control (MAC) and Physical Layer (PHY) specification—Amendment 5: Television White Spaces (TVWS) Operation, approved 11 Dec. 2013 (hereinafter “IEEE Std 802.11af-2013”), which is incorporated herein by reference in its entirety, for more information regarding TVHT PPDUs. In addition, one of ordinary skill in the art would know how to apply these techniques to developing and future PPDU formats, such as, for example, sub-1-GHz (S1G) and High Efficiency (HE) or HE WLAN (HEW) PPDUs.

It might further be possible to special-case the situation where reserved bits are being used, on the basis that if any of them are not the value a reserved bit should be set to (typically zero) then this indicates that a MAC header CRC is present, so that no explicit signalling of this is required. This saves one bit of signalling (allowing it to be used to make the CRC wider) and would work in all but 1 in 2ⁿ cases, where n is the number of reserved bits. In fact, the all-zeros case could be special-cased (see the scrambler initialisation special case for VHT PPDUs above) to remove even that deficiency.

As mentioned at the start, although specific embodiments herein refer solely to using a CRC as the error-check on the MAC header, the present disclosure is not limited thereto, and, as would be understood by one of ordinary skill in the art, any suitable method/system for error-checking could be used, including, but not limited to, a checksum, a parity check, an XOR check, etc.

The general idea of having some sort of error check for the MAC header has been previously discussed. See, e.g., U.S. Pat. Pub. Nos. 2009/0103485 (the '485 app); 2014/0078949 (the '949 app); and 2012/0182980 (the '980 app), the contents of each of which is incorporated by reference in its entirety. However, all of these have inoperable deficiencies and/or compatibility problems. The '949 and '980 apps provide no suggestion of the details of how such an error-check would be implemented, e.g., how and where the error-check bits would be allocated in relation to the MAC frame, whose fields have been allocated already. The solution of the '485 app is to create a new pseudo-field in the data/payload field, without acknowledging or discussing the difficulties in processing this pseudo-field as part of that field (i.e., the contents of which are assumed to be data/payload, not a new MAC header field) in the real world. As a partial address to such concerns, the '485 app suggests much information would be provided by signalling.

As shown by the examples and representative embodiments above, methods, systems, and apparatuses according to the present disclosure provide an error-check for the MAC header of a MPDU, an indicator whether there is such an error-check in a MAC frame, and multiple locations for placing both the indicator and the error-check.

Depending on the embodiment of the present disclosure, steps and/or operations in accordance with the present disclosure may occur in a different order, or in parallel, or concurrently for different epochs, etc., in different embodiments, as would be understood by one of ordinary skill in the art. Similarly, as would be understood by one of ordinary skill in the art, simplified/conceptual representations of the actions performed are discussed herein, and real-world implementations may perform the actions in a different order or by different ways or means. Similarly, as simplified/conceptual representations, required steps as known and understood by one of ordinary skill in the art and not pertinent and/or helpful to the present description are omitted, as would be understood by one of ordinary skill in the art.

Depending on the embodiment of the present disclosure, some or all of the steps and/or operations may be implemented or otherwise performed, at least in part, on a portable device. “Portable device” as used herein refers to any portable, mobile, or movable electronic device having the capability of receiving wireless signals, including, but not limited to, multimedia players, communication devices, computing devices, navigating devices, etc. Thus, mobile devices include, but are not limited to, laptops, tablet computers, Portable Digital Assistants (PDAs), mp3 players, handheld PCs, Instant Messaging Devices (IMD), cellular telephones, Global Navigational Satellite System (GNSS) receivers, watches, cameras or any such device which can be worn and/or carried on one's person. “User Equipment” or “UE” as used herein corresponds to the usage of that term in the 3GPP LTE/LTE-A protocols, but is not in any way limited by the 3GPP LTE/LTE-A protocols. Moreover, “User Equipment” or “UE” refers to any type of device, including portable devices, which acts as a wireless receiver.

Depending on the embodiment of the present disclosure, some or all of the steps and/or operations may be implemented or otherwise performed, at least in part, using one or more processors running instruction(s), program(s), interactive data structure(s), client and/or server components, where such instruction(s), program(s), interactive data structure(s), client and/or server components are stored in one or more non-transitory computer-readable media. In some embodiments of the present disclosure, the one or more processors include radiofrequency (RF) baseband modem chips and/or a system on a chip (SoC).

The one or more non-transitory computer-readable media may be instantiated in software, firmware, hardware, and/or any combination thereof. Moreover, the functionality of any “module” discussed herein may be implemented in software, firmware, hardware, and/or any combination thereof. To clearly illustrate this interchangeability, various illustrative components, blocks, modules, circuits, and steps have been described above generally in terms of their functionality. Whether such functionality is implemented as hardware, firmware, software or some combination thereof depends upon the particular application and design constraints imposed on the overall system. One of ordinary skill in the art would understand how to implement the described functionalities in various ways depending on each particular application/implementation, but such specific implementation/application decisions should not be interpreted as causing a departure from the scope of the present disclosure.

The one or more non-transitory computer-readable media and/or means for implementing/performing one or more operations/steps/modules of embodiments of the present disclosure may include, without limitation, application-specific integrated circuits (“ASICs”), standard integrated circuits, controllers executing appropriate instructions (including microcontrollers and/or embedded controllers), field-programmable gate arrays (“FPGAs”), complex programmable logic devices (“CPLDs”), and the like. Some or all of any system components and/or data structures may also be stored as contents (e.g., as executable or other non-transitory machine-readable software instructions or structured data) on a non-transitory computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of any system components and data structures may also be stored as data signals on a variety of non-transitory computer-readable transmission mediums, from which they are read and then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced in any computer system configuration.

Thus, the term “non-transitory computer-readable medium” as used herein refers to any medium that includes the actual performance of an operation (such as hardware circuits), that includes programs and/or higher-level instructions to be provided to one or more processors for performance/implementation (such as instructions stored in a non-transitory memory), and/or that includes machine-level instructions stored in, e.g., firmware or non-volatile memory. Non-transitory computer-readable media may take many forms, such as non-volatile and volatile media, including but not limited to, a floppy disk, flexible disk, hard disk, RAM, PROM, EPROM, FLASH-EPROM, EEPROM, any memory chip or cartridge, any magnetic tape, or any other magnetic medium from which a computer instruction can be read; a CD-ROM, DVD, or any other optical medium from which a computer instruction can be read, or any other non-transitory medium from which a computer instruction can be read.

While certain embodiments of the present disclosure have been shown and described herein, it will be understood by those of ordinary skill in the art that various changes in form and details may be made therein without departing from the spirit and scope of the present disclosure—i.e., the disclosure is not limited to any embodiments described herein, but is defined by the appended claims and their equivalents.

What is claimed is:

1. A method for generating a medium access control (MAC) protocol data unit (PDU) (MPDU), comprising:
generating an error-check from a header of the MPDU; and
inserting an indicator and the error-check into one or more fields of the MAC header, where the indicator indicates that the MAC header of the MPDU has an error-check.

2. The method of claim 1, wherein the error-check is a cyclic redundancy check (CRC).

3. The method of claim 2, wherein, when the computed CRC is a certain value, the error-check is set to a different value.

4. The method of claim 3, wherein the certain value is all-zeros and the different value is all-ones.

5. The method of claim 2, wherein the CRC is either calculated when all of the bits of the error-check are set to 0, or by excluding all of the bits of the error-check from the calculation.

6. The method of claim 1, wherein the indicator is a one bit flag.

7. The method of claim 1, wherein the indicator and error-check are inserted into the same field of the MAC header.

8. The method of claim 1, wherein the indicator is inserted into one field of the MAC header and the error-check is inserted into another field of the MAC header.

9. The method of claim 1, wherein the bits of the error-check are split up when inserted such that the bits are not contiguous and consecutive within the MAC header.

10. The method of claim 1, wherein the one or more fields of the MAC header into which the indicator and error-check were inserted comprise at least one of a Quality of Service (QoS) field and a High Throughput (HT) control field.

11. A method, comprising:
generating a medium access control (MAC) protocol data unit (PDU) (MPDU);
generating an error-check from the header of the MPDU;
supplying, to the PHY layer, at least one bit from at least one of the error-check and an indicator that the MAC header of the MPDU has the error-check; and
generating, by the PHY layer, a PHY layer PDU (PPDU) from the MPDU and the supplied at least one bit from at least one of the error-check and the indicator that the MAC header of the MPDU has the error-check,
wherein the supplied at least one bit from at least one of the error-check and the indicator that the MAC header of the MPDU has the error-check is not in the MPDU.

12. The method of claim 11, wherein the remaining bits of the error-check and the indicator are inserted into the MAC header.

13. The method of claim 11, wherein the indicator is the supplied at least one bit from at least one of the error-check and the indicator.

14. The method of claim 11, wherein the supplied at least one bit from at least one of the error-check and the indicator is inserted into the SERVICE field of the PPDU.

15. The method of claim 11, wherein the supplied at least one bit comprises the error-check and the indicator.

16. The method of claim 15, wherein the indicator is inserted into one field and the error-check is inserted into another field.

17. The method of claim 15, wherein the indicator and error-check are inserted into the same field.

18. The method of claim 15, wherein the bits comprising the indicator and error-check are non-contiguous and non-consecutive with the PHY header.

19. The method of claim 11, wherein the error-check is a cyclic redundancy check (CRC).

20. The method of claim 11, wherein the indicator is a one bit flag.

21. A modem chip, comprising:
at least one processor; and
at least one non-transitory computer-readable medium storing instructions, which, when executed by one or more of the at least one processor, control the modem chip to perform a method comprising:
generating a medium access control (MAC) protocol data unit (PDU) (MPDU);
generating an error-check from the header of the MPDU;
generating an indicator that the MAC header of the MPDU has an error-check; and
inserting the indicator and error-check into a PDU including the MPDU.

22. The modem chip of claim 21, wherein inserting the indicator and error-check into a PDU including the MPDU comprises:
inserting an indicator and the error-check into one or more fields of the MAC header of the MPDU.

23. The modem chip of claim 21, wherein inserting the indicator and error-check into a PDU including the MPDU comprises:
supplying, to the PHY layer, at least one bit from at least one of the error-check and an indicator that the MAC header of the MPDU has the error-check; and
generating, by the PHY layer, a PHY layer PDU (PPDU) from the MPDU and the supplied at least one bit from at least one of the error-check and the indicator that the MAC header of the MPDU has the error-check,
wherein the supplied at least one bit from at least one of the error-check and the indicator that the MAC header of the MPDU has the error-check is not in the MPDU.
